(19) United States
(12) Patent Application Publication
(10) Pub. No.: US 2015/0002003 A1
(43) Pub. Date: Jan. 1, 2015

(54) VENDING MACHINE ENCLOSURE

(71) Applicant: HON HAI PRECISION INDUSTRY CO., LTD., New Taipei (TW)

(72) Inventor: YUN-LUNG CHEN, New Taipei (TW)

(73) Assignee: HON HAI PRECISION INDUSTRY CO., LTD., New Taipei (TW)

(21) Appl. No.: 14/252,192

(22) Filed: Apr. 14, 2014

(30) Foreign Application Priority Data
Jun. 28, 2013 (CN) 2013102659108

(51) Int. Cl. G07F 9/10

(52) U.S. Cl. CPC G07F 9/10
USPC 312/35

(57) ABSTRACT

A vending machine enclosure includes a chassis, a bottom frame, a door, and a support member. The bottom frame is secured to the chassis. A first end of the door is rotatably mounted to the chassis for opening or closing the chassis. The support member is secured to the bottom frame. A part of the supporting member extends out of the bottom frame. A gap is defined between a bottom wall of the door and the support member. A resisting portion extends from the bottom wall towards the support member. The resisting portion is located in the gap. The resisting portion abuts the support member when a second end of the door is dropped down.

### FIELD

Embodiments of the present disclosure relate to vending machine enclosures, and particularly to a vending machine enclosure with a door.

### BACKGROUND

Vending machine enclosures generally include a chassis and door. A first side of the door is rotatably mounted to the chassis, and a second side of the door is operable to open or close the door. However, the door is often very heavy causing the second side of the door to become oblique relative to the first side. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Like reference numerals designate corresponding parts throughout the several views of the drawings.

FIG. 1 is an exploded, isometric view of one embodiment of a vending machine enclosure.

FIG. 2 is an isometric view of a support member of the vending machine of FIG. 1.

FIG. 3 is an enlarged view of a circled portion III of the vending machine enclosure of FIG. 1.

FIG. 4 is an assembled, isometric view of the vending machine enclosure of FIG. 1.

FIG. 5 is an enlarged view of a circled portion V of the vending machine enclosure of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

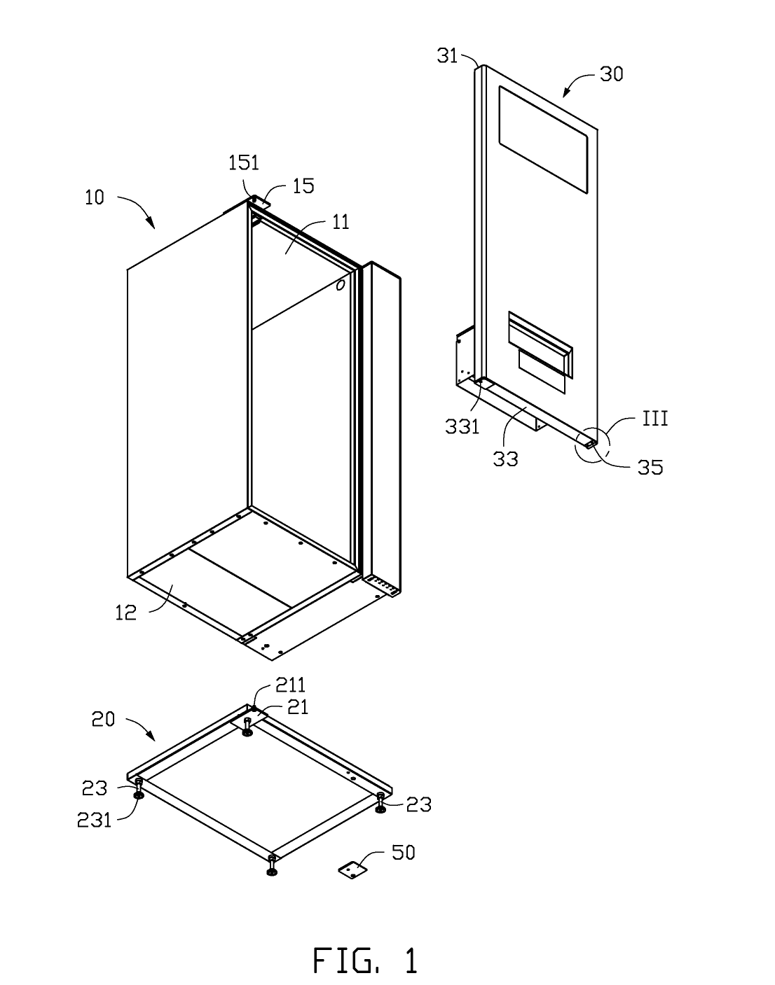

FIG. 1 illustrates one embodiment of a vending machine enclosure. The vending machine enclosure includes a chassis 10, a bottom frame 20, a door 30, and a support member 50.

The chassis 10 includes a top plate 11, a bottom plate 12, a top installation piece 15 located on the top plate 11, and a top pivoting shaft 151 extending downwards from the top installation piece 15. The top plate 11 is substantially parallel to the bottom plate 12.

The bottom frame 20 can be secured to the bottom plate 12 and comprises a bottom installation piece 21, four supports 23, a bottom pivoting shaft 211 extending upwards from the bottom installation piece 21, and a washer 231 secured to a bottom end of each of the four supports 23.

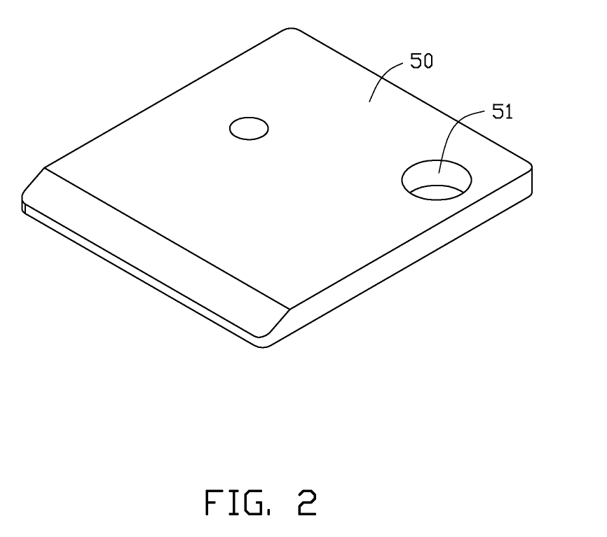

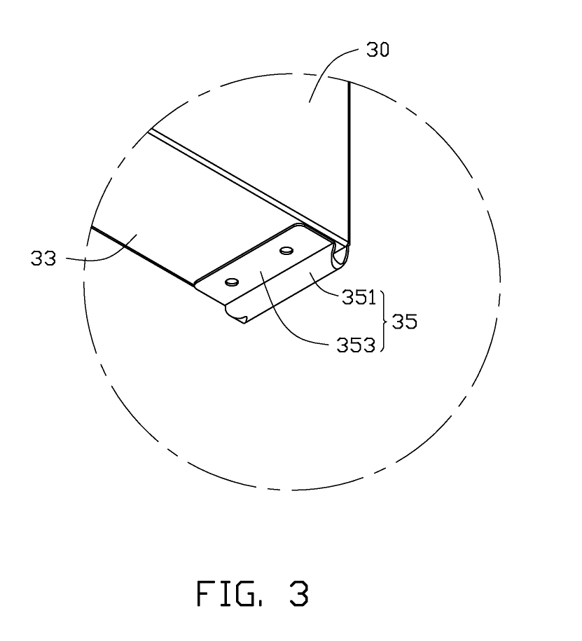

FIGS. 1-3 illustrate the door 30 including a top wall 31 and a bottom wall 33 opposite to the top wall 31. A first side of the top wall 31 defines a first pivoting hole (not shown) corresponding to the top pivoting shaft 151. A first side of the bottom wall 33 defines a second pivoting hole 331 corresponding to the bottom pivoting shaft 211. A resisting portion 35 extends downwards from a second side of the bottom wall 33. The resisting portion 35 includes a resisting end 351 and a securing piece 353. The resisting end 351 extends from the bottom wall 33. The securing piece 353 extends from a distal end of the resisting end 351 and secured to the bottom wall 33 by screws or other methods. The resisting end 351 includes two curved side surfaces connected together. In one embodiment, the securing piece 353 is substantially parallel to the bottom wall 33, and the resisting end 351 is substantially “V” or “U” shaped.

The support member 50 defines a locking hole 51.

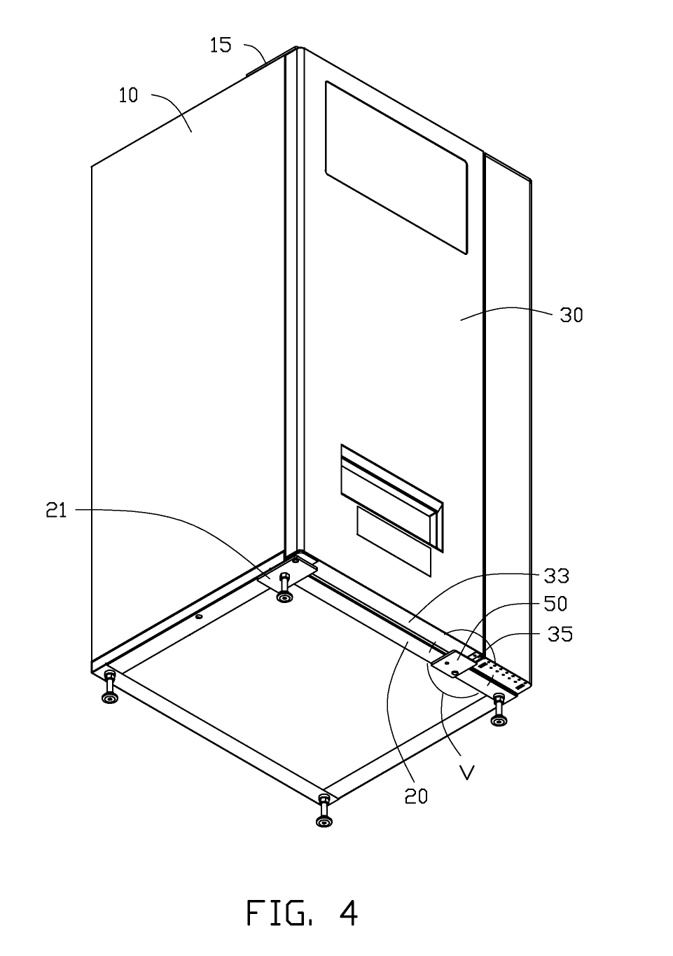

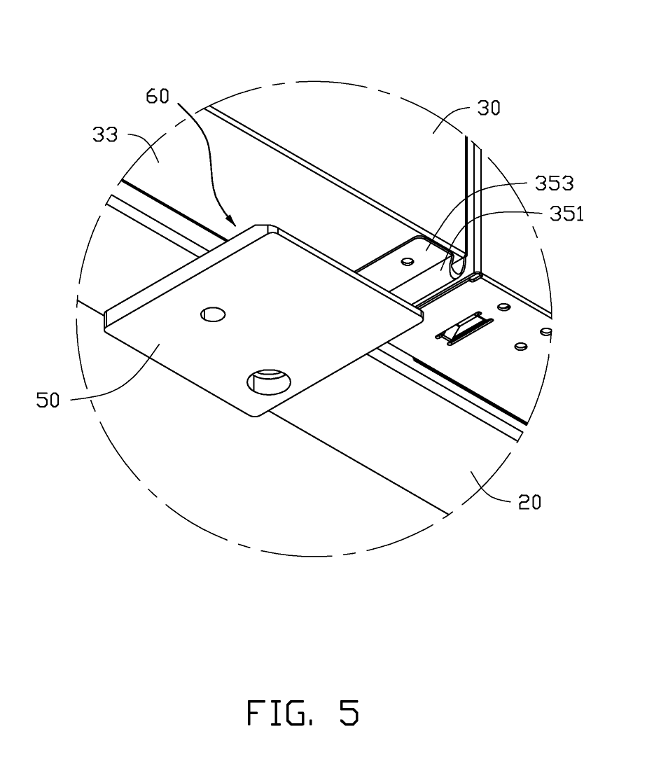

FIG. 4 and FIG. 5 illustrate that in assembly, the bottom frame 20 is secured under the bottom plate 12. The door 30 abuts the top plate 11 and the bottom plate 12. The top pivoting shaft 151 is pivotably received in the first pivoting hole. The bottom pivoting shaft 211 is pivotably received in the second pivoting hole 331. Thus, the door 30 is rotatable relative to the chassis 10 to open or close the chassis 10. A height of the door 30 is substantially equal to a height of the chassis 10 plus the bottom frame 20. The support member 50 abuts a bottom surface of the bottom frame 20 and is positioned under the resisting portion 35. The support member 50 is secured to the bottom frame 20 by screws locking into the locking hole 51, and a part of the support member 50 extends out of the bottom frame 20. An extending direction of the support member 50 is the same as an extending direction of the bottom installation piece 21.

The support member 50 is substantially parallel to the bottom wall 33. A gap 60 is defined between the support member 50 and the bottom wall 33. The resisting portion 35 is located in the gap 60. Thus, when the door 30 sinks down under the force of the gravity, the resisting end 351 will abut the supporting member 50 to block the door 30 from further moving down.

It is to be understood, however, that even though numerous characteristics and advantages have been set forth in the foregoing description of embodiments, together with details of the structures and functions of the embodiments, the disclosure is illustrative only and changes may be made in detail, including in the matters of shape, size, and the arrangement of parts within the principles of the disclosure, to the full extent indicated by the broad general meaning of the terms in which the appended claims are expressed.

What is claimed is:

1. A vending machine enclosure, comprising:
a chassis;
a door with a first side rotatably mounted to the chassis and comprising a bottom wall;
a bottom frame secured under the chassis; and
a support member secured to the bottom frame;
wherein the door further comprises a resisting portion extending from the bottom wall towards the support member; a part of the support member extends out of the bottom frame; a gap is defined between the bottom wall and the support member; and the resisting portion is located in the gap; and the resisting portion abuts the support member when a second side of the door moves downwards.

2. The vending machine enclosure of claim 1, wherein the resisting portion comprises a resisting end and a securing piece, the resisting end extends from the bottom wall towards the support member, and the securing piece extends from a distal end of the resisting end and is secured to the bottom wall.

3. The vending machine enclosure of claim 2, wherein the resisting end is substantially “V” shaped.

4. The vending machine enclosure of claim 2, wherein the securing piece is secured to the bottom wall and substantially parallel to the bottom wall.

5. The vending machine enclosure of claim 1, wherein the chassis comprises a top plate, a bottom plate opposite to the top plate, and a top installation piece located in the top plate; a bottom installation piece is secured to the bottom frame; and the first side of the door is rotatably mounted between the top installation piece and the bottom installation piece.

6. The vending machine enclosure of claim 5, wherein the bottom installation piece extends out of the bottom frame and the bottom plate.

7. The vending machine enclosure of claim 6, wherein an extending direction of the bottom installation piece is same as an extending direction of the support member.

8. The vending machine enclosure of claim 5, wherein a pivoting shaft extends from the bottom installation piece, a first side of the bottom wall defines a pivoting hole, and the pivoting shaft is pivotably received in the pivoting hole; and the resisting portion extends from a second side of the bottom wall.

9. The vending machine enclosure of claim 1, wherein a height of the door is substantially equal to a height of the chassis plus the bottom frame.

10. A vending machine enclosure, comprising:
a chassis;
a door with a first side rotatably mounted to the chassis and comprising a bottom wall;
a bottom frame secured under the chassis; and
a support member secured to the bottom frame;
wherein a height of the door is substantially equal to a height of the chassis plus the bottom frame; a part of the support member extends out of the bottom frame and is located under the bottom wall; the door further comprises a resisting portion extending from the bottom wall towards the support member; the resisting portion is located between the bottom wall and the part of the support member, which extends out of the bottom frame; and the resisting portion abuts the support member when a second side of the door moves downwards.

11. The vending machine enclosure of claim 10, wherein the resisting portion comprises a resisting end and a securing piece, the resisting end extends from the bottom wall towards the support member, and the securing piece extends from a distal end of the resisting end and is secured to the bottom wall.

12. The vending machine enclosure of claim 11, wherein the resisting end is substantially “V” shaped.

13. The vending machine enclosure of claim 11, wherein the securing piece is secured to the bottom wall and substantially parallel to the bottom wall.

14. The vending machine enclosure of claim 10, wherein the chassis comprises a top plate, a bottom plate opposite to the top plate, and a top installation piece located in the top plate; a bottom installation piece is secured to the bottom frame; and the first side of the door is rotatably mounted between the top installation piece and the bottom installation piece.

15. The vending machine enclosure of claim 14, wherein the bottom installation piece extends out of the bottom frame and the bottom plate.

16. The vending machine enclosure of claim 15, wherein an extending direction of the bottom installation piece is same as an extending direction of the support member.

17. The vending machine enclosure of claim 14, wherein a pivoting shaft extends from the bottom installation piece, a first side of the bottom wall defines a pivoting hole, and the pivoting shaft is pivotably received in the pivoting hole; and the resisting portion extends from a second side of the bottom wall.
